(19) United States
(12) Patent Application Publication
(10) Pub. No.: US 2026/0211912 A1
(43) Pub. Date: Jul. 23, 2026

(54) METHODS AND SYSTEM FOR CLOUD-BASED ASSISTANTS AND ANALYTICS

(71) Applicant: QlikTech International AB, Lund (SE)

(72) Inventors: Nicholas R. Magnuson, Park City, UT (US); Henrik Svenell, Malmo (SE); Steven Pressland, Borough Green (GB)

(21) Appl. No.: 19/454,886

(22) Filed: Jan. 21, 2026

Related U.S. Application Data
(60) Provisional application No. 63/747,500, filed on Jan. 21, 2025.

(51) Int. Cl. G06F 16/3329; G06F 16/353; G06F 40/35

(52) U.S. Cl. CPC G06F 16/3329; G06F 16/353; G06F 40/35

(57) ABSTRACT

Described herein are methods and systems for cloud-based assistants and analytics. These methods and systems together provide an architecture for cloud-based assistants and analytics that integrates structured and unstructured data processing. The architecture may include a cloud assistant tier for intent recognition and query routing. The cloud assistant tier may comprise one or more modules or agents that may direct queries to an appropriate global assistant(s), contextual assistant(s), and/or custom assistant. This multi-tiered approach allows for flexible and context-aware processing of both structured and unstructured data, enabling intelligent responses and insights for users across various domains and use cases.

### CROSS-REFERENCE TO RELATED PATENT APPLICATION

This application claims priority to U.S. Prov. App. No. 63/747,500, filed on Jan. 21, 2025, the entirety of which is incorporated by reference herein.

### BACKGROUND

Cloud-based analytics platforms have become increasingly important for businesses seeking to utilize data for decision-making. These platforms offer powerful tools for data visualization, analysis, and reporting. However, many existing solutions struggle to effectively combine structured and unstructured data analysis within a unified interface. Additionally, users often face challenges in navigating complex data sets and extracting meaningful insights without specialized technical knowledge. As organizations accumulate vast amounts of data across various sources, there is a growing need for more intuitive and comprehensive analytics solutions that can seamlessly integrate different data types and provide accessible insights to users at all levels of technical expertise.

### SUMMARY

It is to be understood that both the following general description and the following detailed description are exemplary and explanatory only and are not restrictive.

Described herein are methods and systems for cloud-based assistants and analytics. These methods and systems together provide an architecture for cloud-based assistants and analytics that integrates structured and unstructured data processing. The architecture may include a cloud assistant tier for intent recognition and query routing. The cloud assistant tier may comprise one or more modules or agents that may direct queries to an appropriate global assistant(s), contextual assistant(s), and/or custom assistant. This multi-tiered approach allows for flexible and context-aware processing of both structured and unstructured data, enabling intelligent responses and insights for users across various domains and use cases.

This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1A shows an example system, according to aspects of the present disclosure.

FIG. 1B shows an example system, according to aspects of the present disclosure.

FIG. 2 shows an example user interface, according to aspects of the present disclosure.

FIG. 3 shows an example system architecture, according to aspects of the present disclosure;

FIG. 4 shows an example user interface of an analytics platform, according to aspects of the present disclosure;

FIG. 5 shows an example user interface of the analytics platform, according to aspects of the present disclosure;

FIG. 6 shows an example system, according to aspects of the present disclosure.

FIG. 7 shows a flowchart for an example method, according to aspects of the present disclosure.

FIG. 8 shows a flowchart for an example method, according to aspects of the present disclosure.

FIG. 9 shows a flowchart for an example method, according to aspects of the present disclosure.

### DETAILED DESCRIPTION

This summary is not intended to identify critical or essential features of the disclosure, but merely to summarize certain features and variations thereof. Other details and features will be described in the sections that follow.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint. “Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

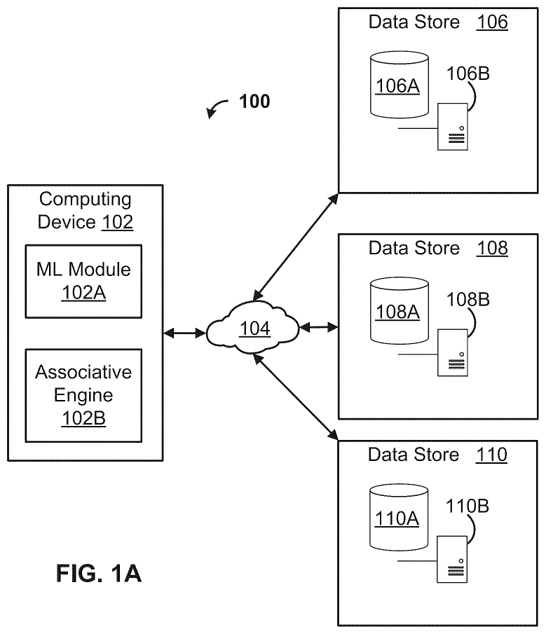

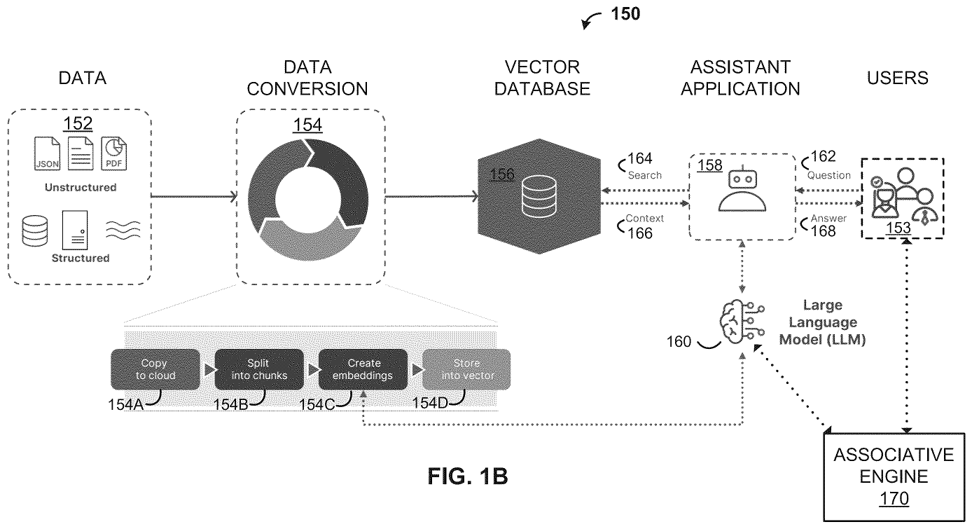

Turning now to FIG. 1A, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1A as being resident at the computing device 102, it is to be understood that the ML module 102A may be resident at one or more computing devices that may be local or remote to the computing device 102. The computing device 102 may comprise an Associative Engine (AE) module 102B. The AE module 102B may store one or more data models in-memory (e.g., within the primary memory/RAM of the computing device 102) and manage associations between data elements. For example, based on data elements within a data model, the AE module 102B may provide near-instantaneous calculation of aggregates, selections, and filters as further described herein.

Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some cases, the system 100 may be integrated with other systems or technologies to enhance its functionality. For example, the system 100 may be integrated with a business intelligence platform, a data warehouse, a customer relationship management system, or other types of systems. This integration may allow the system 100 to access additional data, provide more comprehensive insights, or offer additional features to the users.

As an example, turning now to FIG. 1B, an example system 150 is shown. The system 150 may comprise one or more components of the system 100, as further described herein. That is, the capabilities of the system 150 as described herein also apply to the system 100, as the two systems may share—or may each comprise—each described component, resource, device, etc., that performs each of the actions described herein (and potentially not shown).

In some aspects, the system 150 may be utilized to transform data 152 into a format that may be consumed by one or more Large Language Models (LLMs). For example, the data 152 may comprise both structured data and unstructured data. The structured data may be related to one or more analytics “apps” as further described herein, which may include one or more data models, data tables, information regarding connections to various sources such as databases, spreadsheets, and/or web services in an analytics system, etc. The unstructured data may comprise file-based sources, such as presentations, mail archives, text documents, PDFs, transcripts, etc.

The data 152 may be split into manageable chunks in a data conversion process 154. At step 154A, the data 152 may be copied to a cloud-based environment. At step 154B, the data 152 may be split into chunks (e.g., portions of text data). The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 154C. This conversion may be performed by an LLM or another type of machine learning model. Different types of LLMs may be used depending on the specific requirements of the task. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For ease of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 154C, each chunk may be converted into an embedding via LLM 160 in FIG. 1B (e.g., resident at and/or within the control of the ML module 102A). Though FIG. 1B only shows one LLM 160, it is to be understood that the system 150 may comprise multiple LLMs 160, such as a primary LLM and a secondary LLM as further described herein. Each embedding may comprise a numerical representation of the corresponding chunk of the data 152 that may be consumed/used by an LLM(s) (e.g., by the LLM 160). At step 154D, the embeddings may be stored in a vector database 156 (e.g., resident at and/or controlled by any of the data stores 106, 108, 110). Additionally, the vector database 156 may store embeddings related to unstructured data, such as presentations, mail archives, text documents, PDFs, transcripts, etc.

The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 156 may employ techniques such as dimensionality reduction to optimize the storage and retrieval of embeddings without losing the semantic relationships within the data.

After embeddings are generated and semantically indexed in the vector database 156, an assistant application 158 (e.g., resident at and/or controlled by any of the servers 106B, 108B, 110B), such as a natural language (“NL”) assistant and/or a chatbot, may provide answers to queries related to the data 152. For example, such answers may comprise a NL response(s) and/or one or more visualizations as further described herein. The assistant application 158 may interact with the LLM 160 to process natural language queries from one or more users 153. The one or more users 153 may interact with the assistant application 158 via a client device, such as the computing device 102, a mobile device, or a web browser. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, and/or the like.

As shown in FIG. 1B, the one or more users 153 may send a question 162 The question 162 may comprise a NL query, an image, a recording, a combination thereof, and/or the like. The question 162 may be sent to the assistant application 158. The assistant application 158 may perform a search 164 against the vector database 156 in order to receive context 166. The context 166 may be based on the embeddings stored in the vector database 156 (e.g., the data 152), and the context 166 may be used by the assistant application 158 to provide an answer 168 (e.g., a NL answer/output). In this way, the “knowledge” used by the system 150 to provide answers 168 to questions 162 may be based on the data 152, which may form all or part of the basis for the context 166 provided to the assistant application 158. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. In some aspects, the assistant application 158 may be integrated with other systems or applications to provide additional functionality. For example, the assistant application 158 may be integrated with a customer relationship management system, a content management system, a data analysis system, or any other type of system or application. This integration may allow the assistant application 158 to access additional data, utilize additional computational resources, or provide additional services to users.

In analytics systems (e.g., Software as a Service (SaaS) systems), file-based sources that may be used to generate embeddings for the vector database 156 may be contained within one or more “apps” (short for applications). From a technical standpoint, an app in an analytics system such as the system 150 is a self-contained environment designed to facilitate data analysis and visualization. It serves as a comprehensive workspace where the users 153 can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create embeddings based on apps for the vector database 156, such as for use processing structured data related to natural language queries, the system 150 may determine and structure a comprehensive set of data and metadata from each corresponding app(s). This data forms the foundation of the structured data embeddings stored in the vector database 156, allowing the system 150 to generate accurate and contextually relevant responses (e.g., answers 168) to queries (e.g., searches 164) submitted by the one or more users 153. The system 150 may aggregate/gather details about the data connections, including information about the data sources connected to the app and any necessary authentication credentials, for example. The system 150 may extract information related to the tables and fields imported into each app, as well as the associations between tables and relevant metadata for each field.

The data load script, which may define how data is imported and transformed, may be captured by the system 150, along with any applied data transformations. Information about the sheets and visualizations within the app, including their layout, types, underlying data, and metadata, may also collected by the system 150. This includes reusable dimensions, measures, and master visualizations defined in the app. The system 150 may also collect the content of any stories or presentations built within the app, including the visualizations and text used, as well as titles, descriptions, and relevant metadata. Additionally, details of saved bookmarks, including selections and filters, may be retrieved by the system 150. If the app uses any custom visualizations or extensions, the system 150 may gather information about these custom objects and their metadata.

Understanding the access permissions and data visibility rules configured in the app is also a part of the system 150's process, so details on user roles and their associated permissions may be included. To ensure the vector database 156 remains current and accurate, the system 150 may periodically capture static data extracts or snapshots of the data used in the app. For example, a purpose-built API(s) may be used by the system 150 to programmatically extract the necessary data and metadata, ensuring that all relevant transformations and calculations are captured. The extracted data may then be organized into a structured format suitable for the vector database 156 by the system 150. Including all relevant metadata provides context and enhances the usability of the vector database 156.

Indexing the vector database 156 supports efficient retrieval of information, and techniques such as vectorization and semantic search, as performed by the vector database 156, enhance the retrieval capabilities for the system 150. Finally, setting up processes to periodically update the vector database 156 with new data and changes from the app ensures the vector database 156 remains current and accurate. By extracting and structuring this comprehensive set of information from an app, the system 150 may create—and maintain—robust knowledge bases corresponding to the structured data, enabling it to provide accurate and contextually relevant answers 168 to user queries/questions 162.

To transform data from an app for use in the system 150, several steps are taken to ensure the data is appropriately structured and accessible for generating accurate and contextually relevant responses. First, data from the app is extracted by the system 150. This includes data from various sources connected to the app, as well as the data model, which comprises tables and their relationships. The data load script and any transformations applied within the app may be replicated by the system 150 to maintain consistency.

Once extracted, the data may be cleaned and preprocessed by the system 150. This may involve handling missing values, normalizing data formats, ensuring that all the transformations applied by the system 150 are consistent, a combination thereof, and/or the like. The goal of data cleaning and preprocessing is to create a structured dataset that the system 150 may easily index and query. The described embeddings, which are dense vector representations of the data, may be created by the system 150, capturing the semantic meaning of textual content.

Text data associated with an app, such as descriptions, titles, and narratives, may be processed using Natural Language Processing (NLP) techniques (e.g., by the LLM 160). For example, models such as BERT, GPT, and/or other transformer-based models may be used by the system 150 to convert the data into embeddings as well (or in the alternative). For structured data, feature vectors representing all numerical attributes and/or categorical attributes within the structured data may be created by the system 150. Techniques like principal component analysis (PCA) and/or use of one or more autoencoders may be used by the system 150 to reduce dimensionality and create embeddings. The embeddings may then be indexed by the vector database 156. This indexing permits efficient similarity searches, enabling the system 150 to quickly retrieve relevant data points based on the query embeddings.

The embedded data forms a knowledge base, which includes indexed embeddings and associated metadata, ensuring that the context and relationships within the data are preserved by the system 150. Such knowledge bases may be stored in the vector database 156, which for purposes of explanation is shown in FIG. 1B as being a single vector database 156 but in some examples may comprise a plurality of vector databases 156. The system 150 may use knowledge bases stored in the vector database(s) 156 (and/or elsewhere) to generate responses as described herein. When a user's 153 question 162 is received, the system 150 may convert the question 162 into an embedding, retrieve relevant data from the vector database 156 using vector search, and/or generate responses using the assistant application 158. The retrieved data forms a context 166 that is then used to provide a contextually accurate and relevant answer(s) 168.

Additionally, the context 166 may comprise contextual metadata. As shown in FIG. 1B, the system 150 may further comprise an associative engine 170. The associative engine 170 may correspond to the AE module 102B of the computing device 102 (e.g., the client device(s) associated with the user(s) 153). When a user 153 sends a question 162, (e.g., seeks an insight(s) by asking a natural language question and/or by interacting with a visual analytic interface by selecting a chart or a portion of a chart for explanation), the associative engine 170 gathers contextual metadata about the user's 153 current analytical context. This contextual metadata can include, but is not limited to: data hypercubes or subsets relevant to the question 162 (e.g., dimensions, measures, and/or their values), a current selection state (e.g., filters applied, like specific regions, products, or time periods selected), a data model schema and/or relationships (e.g. how fields and tables are connected), the user's 153 selection or query history (e.g., what the user 153 looked at or asked just before, to maintain context in a conversational thread), and/or any annotations or rules defined in a corresponding analytics-system app (e.g., labels like “High-value customer” or custom calculations defined by the user 153).

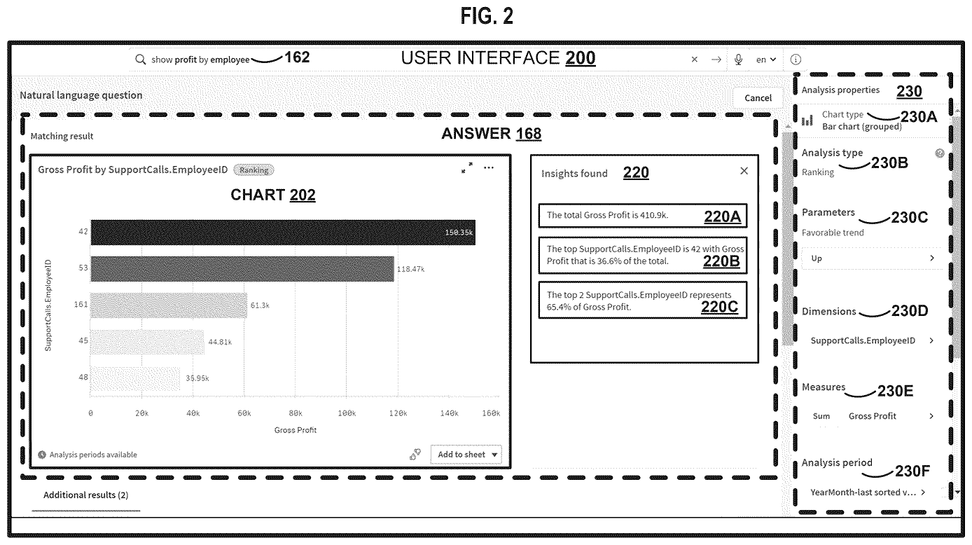

Turning now to FIG. 2, an example user interface 200 is shown. The user interface 200 may provide an interactive environment for users to engage with the natural language processing and insight generation capabilities of the systems described herein. The user interface 200 may be displayed on a computing device, such as the computing device 102 shown in FIG. 1A (e.g., accessed through a web browser or application running on a client device).

The user interface 200 may include a question 162 input field. The question input field 162 may allow users to enter natural language queries or requests for insights about specific data or visualizations. The question 162 shown in the user interface 200 may correspond to the question 162 described in FIG. 1B. Users may enter natural language queries into this field to request insights about their data. The question 162 may be processed by the assistant application 158 as described in relation to FIG. 1B. The input field may support various types of queries, ranging from simple data requests to complex analytical questions. Users may ask questions such as “What were the top products last quarter?” or “Show me sales trends by region.” The system may interpret these natural language inputs and convert them into appropriate data operations.

The user interface 200 may also display an answer 168 in response to the user's question 162. The answer 168 shown in the user interface 200 may correspond to the answer 168 generated by the system 150 as described in FIG. 1B. The answer 168 may comprise natural language text that provides insights, explanations, and interpretations of the data. The answer 168 may be generated using the large language model(s) 160 and may incorporate contextual metadata from the associative engine 170. The natural language response may be tailored to the user's specific query and may include relevant details, comparisons, and observations about the data. The answer 168 may comprise natural language text that provides insights, explanations, or responses to the user's query.

A chart 202 may be displayed within the user interface 200. The chart 202 may provide a visual representation of data relevant to the user's query or the current analytical context. The chart 202 may be generated based on data retrieved from the associative engine 170 and/or from the vector database 156. The chart 202 may be interactive, allowing users to click on specific elements to request additional insights or explanations. The visualization may be automatically selected based on the type of analysis being performed and the nature of the data being displayed. The chart 202 may be a visual representation of data relevant to the user's query or the current context of analysis.

The user interface 200 may generate and display a plurality of insights 220. These insights may be automatically generated based on the current data context and may provide users with additional analytical observations beyond their specific query. The plurality of insights 220 may include a first insight 220A, a second insight 220B, and a third insight 220C. Each insight may represent a different analytical finding or observation about the data. These insights may be generated using the template-based approaches described herein, combined with the natural language generation capabilities of the large language models. The insights may be generated by the system 150 based on the data represented in the chart 202, the user's query, and other contextual information. Each of these insights may provide different perspectives or analyses of the data.

The system may also provide analysis properties 230 that support the generated insights. The analysis properties 230 may include detailed analytical information that forms the foundation for the insights presented to the user. These properties may include a first analysis property 230A, a second analysis property 230B, a third analysis property 230C, a fourth analysis property 230D, a fifth analysis property 230E, and a sixth analysis property 230F. Each analysis property may contain specific data points, measurements, calculations, or metadata that contribute to the overall insight generation process. The analysis properties 230 may be derived from the contextual metadata provided by the associative engine 170 and may include information such as current selection states, hypercube data, statistical measures, and comparative values.

The analysis properties 230 may serve multiple purposes within the system. They may provide the factual foundation for the natural language insights, ensuring that the generated text is grounded in actual data rather than hallucinated information. The properties may also be used to construct prompts for the large language models, providing the necessary context and data points for generating accurate and relevant responses. Additionally, the analysis properties 230 may be used to determine appropriate visualizations and to guide the narrative structure of the insights.

The user interface 200 may support interactive exploration of data. Users may click on elements of the chart 202 to request explanations or additional insights about specific data points. The system may respond to these interactions by generating new insights or by providing more detailed analysis of the selected elements. This interactive capability may be supported by the associative engine 170. The associative engine 170 can quickly retrieve relevant contextual information about any selected data point or visualization element. The chart 202 and the insights 220 may be dynamically updated based on user interactions. For example, if a user selects a particular bar in the chart 202, the system 150 may generate new insights specific to that selection. This interactive capability may be facilitated by the associative engine 170. The associative engine 170 can quickly retrieve and analyze relevant data based on user selections.

The user interface 200 may also include additional interactive elements not explicitly shown in FIG. 2. These may include filters, dropdown menus, or buttons that allow users to refine their queries, change data views, or access additional features of the system 150. The integration of natural language input, visual data representation, and AI-generated insights in a single interface demonstrates the system's capability to provide a comprehensive analytical experience. This approach may allow users of varying technical expertise to gain valuable insights from complex data sets.

The user interface 200 may be part of a larger application or dashboard system. It may be one of several “sheets” within an analytics app, as described earlier. The data and insights presented in the user interface 200 may be derived from the data model and connections established within such an app. The system 150 may use both the vector database 156 and the associative engine 170 to generate the content displayed in the user interface 200. The vector database 156 may provide relevant context and background information based on the user's query, while the associative engine 170 may perform real-time calculations and data retrievals to support the insights and visualizations.

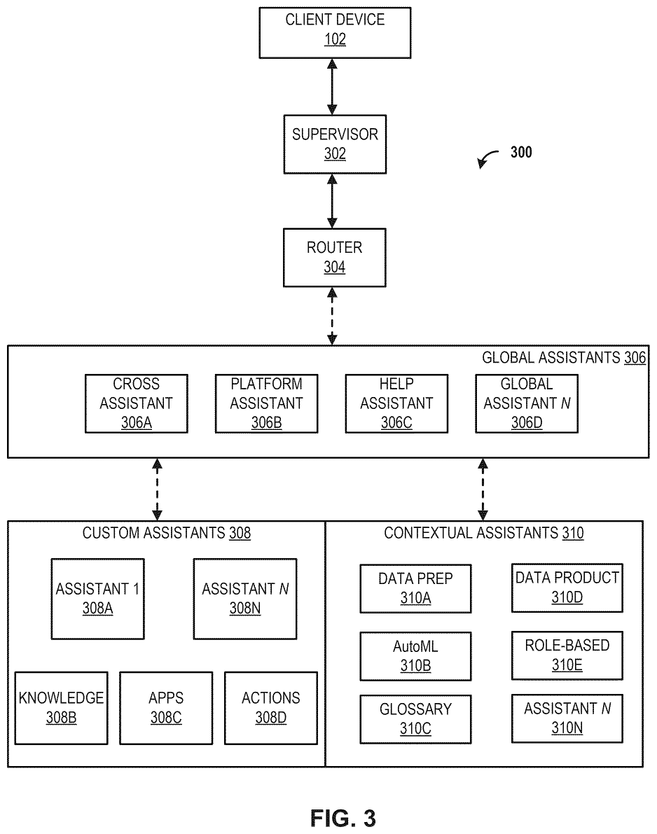

Referring to FIG. 3, an architecture 300 may implement the functionality of the system 150 shown in FIG. 1B. The architecture 300 may comprise a multi-tiered assistant system. The multi-tiered assistant system may process queries from a client device 102. The client device 102 may correspond to the computing device 102 shown in FIG. 1A, which may comprise the ML module 102A and the associative engine 102B. The client device 102 may communicate with a supervisor 302. The supervisor 302 may be responsible for receiving and analyzing user queries. The supervisor 302 may serve as an initial point of contact for user queries. The supervisor 302 may receive queries from various user interfaces or input methods. The supervisor 302 may correspond to the supervisor module described in the cloud assistants tier, which may be responsible for processing initial queries from users.

The supervisor 302 may perform intent recognition. The intent recognition may comprise analyzing the content and context of a user's query to determine the underlying intent or purpose. The supervisor 302 may extract query intent beyond the literal text of the query. The supervisor 302 may identify implicit requirements, constraints, and desired outcomes. The supervisor 302 may classify queries into functional categories. The functional categories may include analytical, administrative, help-seeking, or action-requesting categories. Other examples are possible as well. The supervisor 302 may classify queries along multiple dimensions. The multiple dimensions may include a functional intent, a domain context, data requirements, an execution profile for single or multi-agent execution, and a complexity level. Other examples are possible as well.

In some cases, the supervisor 302 may determine, based on a natural language query, an intent representation comprising a query intent and the domain context. The determining of the intent representation may comprise classifying, via at least one large language model, the natural language query into the query intent and the domain context. The at least one large language model may be associated with an assistant platform. The at least one large language model may correspond to the large language model 160 shown in FIG. 1B, which may interact with the assistant application 158 to process natural language queries from users 153. The supervisor 302 may be designed to handle a wide range of query types and intents. This versatility may allow the architecture 300 to efficiently process and respond to diverse user needs and requests. The supervisor 302 may also be scalable, allowing it to handle multiple user queries simultaneously and route them to appropriate system components for parallel processing.

With continued reference to FIG. 3, the supervisor 302 may be in communication with a router 304. The router 304 may direct queries to appropriate assistants based on determined intent. The supervisor 302 and the router 304 may work in conjunction to process and route user queries efficiently. For example, when a user submits a query, the supervisor 302 may first analyze the query to determine its intent. The supervisor 302 may then pass this intent information to the router 304. The router 304 may use this intent information to direct the query to the appropriate component of the architecture 300 for further processing. The router 304 may maintain a registry of all available assistants at a global assistants tier. Each assistant may be described by functional capabilities and specializations. Each assistant may be described by use cases and recommended query types. Each assistant may be described by domain applicability. Each assistant may be described by required data sources and integrations. Each assistant may be described by semantic descriptions for matching.

The stored registry of agent entries may comprise, for each agent in a tier of agents, a tenant identifier. The tenant identifier may uniquely identify a tenant within a multi-tenant environment of the assistant platform. The tenant identifier may be used to enforce tenant data isolation, ensuring that each tenant only accesses agents and data associated with that tenant. The stored registry of agent entries may associate each agent in the second tier of agents with one or more tenant identifiers, enabling the router 304 to filter available agents based on the tenant context of an incoming request. The first tier of agents may comprise global assistants 306 that are shared across multiple tenants, while the second tier of agents may comprise custom assistants 308 and contextual assistants 310 that are tenant-specific. The tenant identifier may be extracted from the natural language query, from authentication credentials associated with the user device, or from session metadata associated with the request. The router 304 may use the tenant identifier to restrict agent selection to agents that are authorized for the identified tenant. For example, when determining the target agent, the router 304 may filter the stored registry of agent entries to include only agents whose tenant identifier matches the tenant identifier associated with the request. This filtering may ensure that a user associated with a first tenant cannot access custom assistants 308 or contextual assistants 310 that are configured for a second tenant. The tenant identifier may also be used to enforce data access controls at the data source level, ensuring that agents only query data models and analytics applications that are authorized for the identified tenant.

The router 304 may use the intent information to determine which specific assistant or module within the architecture 300 is best suited to handle the user's query. For example, the router 304 may perform semantic matching of query intent to assistant capabilities. The router 304 may use a semantic assistant selection algorithm. The semantic assistant selection algorithm may include candidate generation. The semantic assistant selection algorithm may include filtering by data requirements and permissions. The semantic assistant selection algorithm may include ranking by semantic similarity score and historical success rate. The semantic assistant selection algorithm may include selection of primary and secondary assistants. In some cases, determining a first assistant may comprise determining, based on the intent representation and at least one capability descriptor for each of a plurality of assistants, a similarity score for each of the plurality of assistants. Determining the first assistant may comprise determining, based on the similarity score, the first assistant.

The router 304 may perform adaptive routing. The adaptive routing may comprise routing adjustments made based on interim results during query execution. The router 304 may direct queries to other components of the architecture 300, such as the global assistants 306 or the contextual assistants 310. The queries processed by the supervisor 302 may then be routed by the router 304 to other components of the architecture 300. The router 304 may be in communication with global assistants 306. The global assistants 306 may comprise a set of platform-level assistants. The global assistants 306 may process and respond to various types of user queries. In some cases, the global assistants 306 may receive queries from the supervisor 302 and the router 304 after initial processing and routing. The global assistants 306 may include a cross assistant 306A. The cross assistant 306A may be configured to handle queries requiring coordination between multiple specialized assistants. The cross assistant 306A may integrate information from various sources to provide comprehensive responses to complex queries. The global assistants 306 may include a platform assistant 306B. The platform assistant 306B may be configured to handle platform-specific actions. The platform assistant 306B may process queries related to system configuration, user management, or other platform-level operations. The platform assistant 306B may communicate with the assistant application 158 shown in FIG. 1B to execute platform-specific actions. The global assistants 306 may include a help assistant 306C. The help assistant 306C may be configured to provide assistance with product documentation and usage. The help assistant 306C may access a knowledge base of product information to answer user queries about features, functionality, or troubleshooting. The help assistant 306C may access the vector database 156 shown in FIG. 1B to retrieve relevant documentation for user queries. The global assistants 306 may include a global assistant N 306D. The global assistant N 306D may represent additional extensible assistants. The architecture 300 may include an explicit extensibility point enabling addition of new assistants as new capabilities are developed without architectural changes.

The global assistants 306 may include an analytics agent. The analytics agent may query applications and underlying data models. The analytics agent may not rely on text-to-SQL translation. The analytics agent may leverage an associative analytics engine directly. The associative analytics engine may correspond to the associative engine 170 shown in FIG. 1B or the associative engine 102B shown in FIG. 1A. The analytics agent may access pre-curated, governed data models with metrics, dimensions, and KPIs. The analytics agent may be responsible for processing data analysis queries. The analytics agent may interact with the vector database 156 shown in FIG. 1B and the large language model 160 to generate insights and visualizations based on user queries. The global assistants 306 may include an automation agent. The automation agent may execute workflows and query processes. The automation agent may integrate with automation systems to trigger data operations. The automation agent may trigger query process workflows. The automation agent may trigger system integrations. The automation agent may trigger API calls to external systems. In some cases, causing the execution of a task may further comprise triggering, based on a task result, an automation workflow that modifies a record in an external application. The global assistants 306 may include productivity agents. The productivity agents may embed contextual assistance within user workflows. The productivity agents may provide real-time help and guidance. The productivity agents may provide step-by-step instruction. The productivity agents may provide code generation and script assistance. The productivity agents may provide data literacy support. In some cases, the global assistants 306 may use the large language model 160 shown in FIG. 1B to process natural language queries and generate human-like responses. The global assistants 306 may also interact with the contextual assistants 310 to provide domain-specific information when needed.

As further shown in FIG. 3, the architecture 300 may include custom assistants 308. The custom assistants 308 may be user-created assistants designed for specialized tasks. The custom assistants 308 may be tailored to specific needs or use cases that are not covered by the global assistants 306. The custom assistants 308 may be generated by users to handle particular types of queries or perform specific operations. The custom assistants 308 may include an assistant 1 308A and an assistant N 308N. The custom assistants 308 may be built through UI-based configuration. The UI-based configuration may combine knowledge 308B, apps 308C, and actions 308D. The knowledge 308B may represent knowledge bases containing unstructured data sources. The unstructured data sources may correspond to the unstructured data described in FIG. 1B, which may comprise file-based sources such as presentations, mail archives, text documents, PDFs, and transcripts. The apps 308C may represent linked analytics applications containing structured data through pre-built data models. The structured data may correspond to the structured data described in FIG. 1B, which may be related to one or more analytics applications including one or more data models, data tables, and information regarding connections to various sources such as databases, spreadsheets, and web services. The actions 308D may represent automation workflows. The automation workflows may be triggered based on query results.

The custom assistants 308 may access and reason over multiple applications simultaneously. The custom assistants 308 may enable queries requiring correlating data from multiple sources. An associative engine may manage correlations between the multiple sources. The associative engine may correspond to the associative engine 170 shown in FIG. 1B or the associative engine 102B shown in FIG. 1A. The associative engine may store one or more data models in-memory and manage associations between data elements. A custom assistant creation workflow may include selecting knowledge bases. The custom assistant creation workflow may include linking applications. The custom assistant creation workflow may include connecting automations. The custom assistant creation workflow may include configuring access and sharing. The custom assistants 308 may interact with other components of the system 150 shown in FIG. 1B, such as the vector database 156 and the large language model 160. In some cases, the custom assistants 308 may use the vector database 156 to retrieve relevant information for processing queries. The custom assistants 308 may also utilize the large language model 160 to generate responses or perform specific tasks.

The knowledge base integration may include fine-grained filtering. Users may access a custom assistant without seeing restricted knowledge bases. The filtering may be applied at a semantic search retrieval stage. The custom assistant access control may include a fine-grained permission model. The same custom assistant may be configured with different permission levels for different users. Enforcement may be applied at the semantic search retrieval stage. Enforcement may be applied at a data query stage through access rules. Enforcement may be applied at an automation execution stage. In some cases, the plurality of assistants may comprise at least one custom assistant associated with a data model. Determining the first assistant may comprise enforcing, based on a user role associated with a user device, an access rule that restricts selection of the at least one custom assistant. Understanding the access permissions and data visibility rules configured in an application may be part of the system's process, so details on user roles and their associated permissions may be included. The security rules may define access permissions and data visibility, ensuring that users only see the data they are authorized to access.

With continued reference to FIG. 3, the architecture 300 may include contextual assistants 310. The contextual assistants 310 may be domain-specific assistants tailored to particular contexts. The contextual assistants 310 may have access to specialized knowledge bases or data sources relevant to their particular contexts. The contextual assistants 310 may be designed to provide assistance within specific domains or industries. The contextual assistants 310 may be available to all tenants using a functional domain. Tenant data isolation may be applied. The assistant may be shared but each tenant may access only its own data. The plurality of agents may comprise a first tier of agents. The first tier of agents may be shared across multiple tenants. The plurality of agents may comprise a second tier of agents. The second tier of agents may be associated with respective tenants. The contextual assistants 310 may receive queries routed from the supervisor 302 and the router 304 or from the global assistants 306. The contextual assistants 310 may process these queries using their specialized knowledge or capabilities.

The contextual assistants 310 may include a data prep 310A assistant. The data prep 310A assistant may be configured for data preparation tasks. The contextual assistants 310 may include an AutoML 310B assistant. The AutoML 310B assistant may be configured for machine learning task assistance. The AutoML 310B assistant may interact with the ML module 102A shown in FIG. 1A, which may comprise and facilitate access to a plurality of ML models such as at least one neural network, at least one Large Language Model, at least one segmentation model, at least one ensemble model, a combination thereof, or the like. The contextual assistants 310 may include a glossary 310C assistant. The glossary 310C assistant may be configured for terminology and definitions. The contextual assistants 310 may include a data product 310D assistant. The data product 310D assistant may be configured for data product related queries. The contextual assistants 310 may include a role-based 310E assistant. The role-based 310E assistant may be configured for role-specific assistance. The contextual assistants 310 may include an assistant N 310N. The assistant N 310N may represent additional contextual assistants. The contextual assistants 310 may interact with other components of the system 150 shown in FIG. 1B, such as the vector database 156 and the large language model 160. In some cases, the contextual assistants 310 may use the vector database 156 to retrieve relevant information for processing queries. The contextual assistants 310 may also utilize the large language model 160 to generate responses or perform specific tasks.

The global assistants 306 may be in communication with both the custom assistants 308 and the contextual assistants 310. Queries may be routed from platform-level assistants to more specialized assistants based on the nature of the query. The hierarchical arrangement may allow the architecture 300 to process queries through multiple tiers. The supervisor 302 and router 304 may direct queries to appropriate global assistants 306. The global assistants 306 may utilize custom assistants 308 or contextual assistants 310 to generate comprehensive responses. The integration of custom assistants 308 and contextual assistants 310 into the architecture 300 may allow the system 150 shown in FIG. 1B to handle a wide range of specialized queries and tasks. This integration may enable the system 150 to provide tailored assistance across various domains and use cases. The modules within the global assistants 306 may interact with each other and with other components of the system 150 to process queries and generate responses. The global assistants 306 may be designed to handle a wide range of query types efficiently. By incorporating specialized modules, the global assistants 306 may provide accurate and relevant responses to diverse user needs within the system 150.

The architecture 300 may support multi-agent orchestration. A single query requiring multiple assistants may be decomposed into constituent parts. An execution sequence may be determined as sequential or parallel based on dependencies. Results from one assistant may become context for a next assistant. In some cases, a method performed by one or more entities of the system 150 may comprise receiving, via an assistant platform, a natural language query from a user device associated with the assistant platform. The natural language query may correspond to the natural language question 162 shown in FIG. 1B. The method may comprise determining, based on the natural language query, an intent representation comprising a query intent and a domain context. The method may further comprise determining, based on the intent representation, a first assistant of a plurality of assistants. Each assistant of the plurality of assistants may be associated with at least one data source. The at least one data source may correspond to the plurality of data stores 106, 108, 110 shown in FIG. 1A. The method may further comprise causing, based on the first assistant and the at least one data source, an execution of a task by a computation service of the assistant platform. The computation service may correspond to the associative engine 170 shown in FIG. 1B or the associative engine 102B shown in FIG. 1A.

The execution of the task may comprise evaluating a data model associated with the at least one data source. The data model may be evaluated based on the query intent and the domain context. In some cases, causing the execution of the task may comprise sending, via the first assistant, a query message encoding a maintained selection state to an associative engine. The associative engine may implement the computation service and evaluate the data model. The maintained selection state may be stored, based on a session identifier associated with the natural language query, in a state store of the computation service and reused for multiple task executions within a session defined by the session identifier. The method may further comprise receiving, based on the execution of the task, a task result from the computation service. The task result may correspond to the context 166 shown in FIG. 1B. The method may further comprise generating, based on the task result, a natural language response. The natural language response may correspond to the answer 168 shown in FIG. 1B. Finally, the method may comprise sending, to the user device via the assistant platform, the natural language response.

The system 150 shown in FIG. 1B may be capable of triggering actions and automated processes based on insights derived from user queries. In some cases, the assistant application 158 may analyze the natural language question 162 and the generated answer 168 to identify potential actions. The assistant application 158 may then initiate these actions through appropriate components of the system 150 or external systems. For example, if a natural language question 162 relates to a specific data trend, the system 150 may not only provide an answer 168 describing the trend but may also trigger an automated process to generate a detailed report or alert relevant stakeholders. In some cases, these automated processes may be executed by components within the global assistants 306 or custom assistants 308 of the architecture 300. The interaction between the users 153, the assistant application 158, and the large language model 160 may be iterative. In some cases, the system 150 may engage in a multi-turn conversation with the users 153, refining and expanding upon the initial natural language question 162 and answer 168. This iterative process may allow for more comprehensive and accurate responses to complex queries.

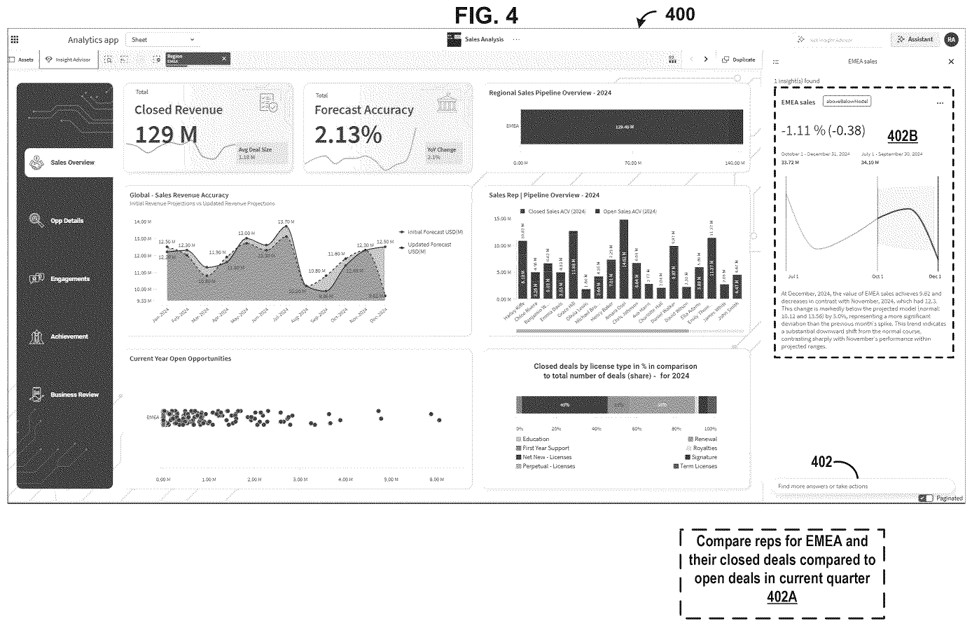

Referring to FIG. 4, an analytics interface 400 may provide an interactive environment for users to interact with data and receive responses to queries. The analytics interface 400 may integrate with the assistant application 158 of FIG. 1B and the architecture 300 of FIG. 3. The analytics interface 400 may serve as a component of the assistant application 158 shown in FIG. 1B, which interacts with the large language model 160 to process natural language queries from users 153. The analytics interface 400 may also serve as a component of any of the assistants within the architecture 300, including the global assistants 306, the custom assistants 308, and the contextual assistants 310 shown in FIG. 3. The analytics interface 400 may be used to present data and visualizations to users. The analytics interface 400 may also allow users to interact with the data and initiate queries. In some cases, the analytics interface 400 may be embedded in external portals or applications. This embedding capability may allow users to access the functionality of the system 150 from within other software environments or platforms. The embedded analytics interface 400 may maintain its full range of capabilities, including access to the various tiers of assistants described in the architecture 300.

The analytics interface 400 may include a chatbox 402. The chatbox 402 may allow users to input queries in natural language form. The chatbox 402 may also display responses generated by the assistant application 158 or by assistants within the architecture 300. When a user inputs a query into the chatbox 402, the query may be processed by the supervisor 302 shown in FIG. 3. The supervisor 302 may perform intent recognition on the query to determine the underlying intent or purpose. The supervisor 302 may then pass this intent information to the router 304. The router 304 may use this intent information to direct the query to the appropriate assistant within the global assistants 306, such as the cross assistant 306A, the platform assistant 306B, the help assistant 306C, or other specialized assistants. This functionality may be directly linked to the cloud assistants tier comprising the supervisor 302 and the router 304 of the architecture 300.

With continued reference to FIG. 4, the chatbox 402 may display a natural language query 402A. The natural language query 402A may function similarly to the natural language question 162 described above with reference to FIG. 1B. For example, the natural language query 402A may comprise a text string entered by a user seeking information about data displayed in the analytics interface 400. Specifically, the natural language query 402A shown in FIG. 4 reads “Compare reps for EMEA and their closed deals compared to open deals in current quarter.” Other examples of natural language queries 402A are possible as well. The ability to handle natural language queries may be facilitated by the large language model 160 described in FIG. 1B, which may be integrated into the architecture 300. The natural language query 402A may be received by the assistant application 158, which may then perform a search 164 against the vector database 156 to retrieve context 166 relevant to the query.

The chatbox 402 may further display a generated response 402B. The generated response 402B may correspond to the answer 168 described above with reference to FIG. 1B. The generated response 402B may comprise textual content providing information responsive to the natural language query 402A. The generated response 402B may be formulated using context 166 retrieved from the vector database 156 and processed by the large language model 160 as shown in FIG. 1B. The system 150 may utilize retrieval augmented generation to enhance responses. In some cases, the assistant application 158 may provide the retrieved context 166 to the large language model 160. The large language model 160 may use the context 166 to generate the answer 168, which is displayed as the generated response 402B. The generated response 402B may also be generated by an appropriate assistant within the global assistants 306 or the contextual assistants 310 of the architecture 300, depending on the nature of the query. For example, if the natural language query 402A relates to analytics data, the router 304 may direct the query to an analytics agent within the global assistants 306, which may query applications and underlying data models. The analytics agent may leverage the associative engine 170 shown in FIG. 1B directly, which may correspond to the associative engine 102B shown in FIG. 1A. The associative engine 170 may store one or more data models in-memory and manage associations between data elements, enabling near-instantaneous calculation of aggregates, selections, and filters.

As further shown in FIG. 4, the analytics interface 400 may display multiple visualizations in a main area. The visualizations may be generated using data processed by components of the architecture 300. For example, the visualizations may be generated based on data processed by the global assistants 306 or the contextual assistants 310. The visualizations may include various types of charts and graphs. For example, the visualizations may include bar charts, scatter plots, line charts, and numerical indicators. Other types of visualizations are possible as well. The visualizations may be dynamically updated based on user interactions and queries. For example, when a user selects a specific data point in one visualization, other visualizations in the analytics interface 400 may update to show related information.

This dynamic updating may be facilitated by the associative engine 170, which gathers contextual metadata about the user's current analytical context. This contextual metadata can include data hypercubes or subsets relevant to the query, a current selection state including filters applied such as specific regions, products, or time periods selected, a data model schema and relationships showing how fields and tables are connected, the user's selection or query history to maintain context in a conversational thread, and any annotations or rules defined in a corresponding analytics-system app.

In some cases, the analytics interface 400 may allow for dynamic interaction between the visualizations and the chatbox 402. For example, a user may be able to click on a specific element of a visualization, which may automatically generate a query in the chatbox 402. This interaction may demonstrate the integration between the various components of the architecture 300, such as the global assistants 306 and the contextual assistants 310. The analytics interface 400 may also include tools for customizing the displayed visualizations. These tools may allow users to adjust parameters, apply filters, or change chart types. This functionality may be supported by the custom assistants 308 within the architecture 300, which may be designed to handle specific types of data manipulation or visualization tasks. The custom assistants 308 may be configured with knowledge 308B representing knowledge bases containing unstructured data sources, apps 308C representing linked analytics applications containing structured data through pre-built data models, and actions 308D representing automation workflows that may be triggered based on query results.

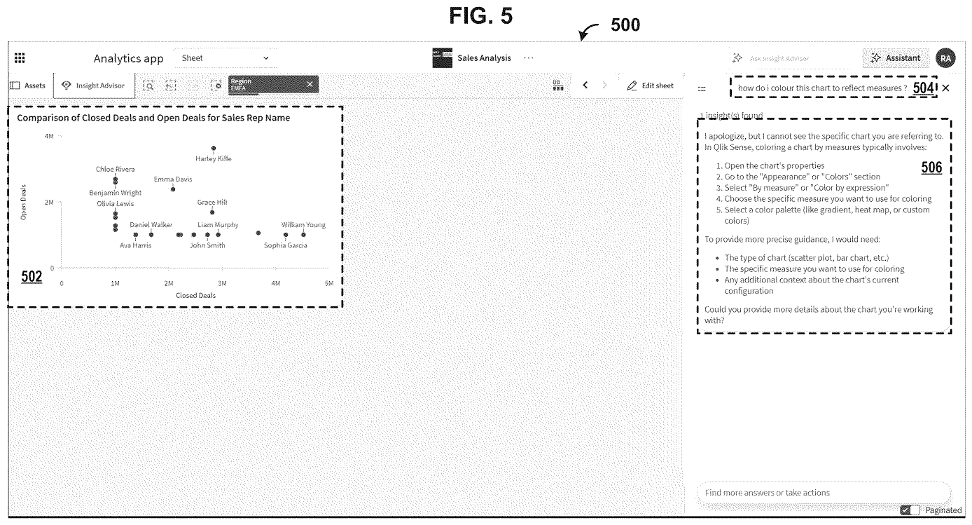

Referring to FIG. 5, an analytics interface 500 is shown according to aspects of the present disclosure. The analytics interface 500 may be a component of the assistant application 158 described above with reference to FIG. 1B, which interacts with the large language model 160 to process natural language queries from users 153. The analytics interface 500 may also be a component of any of the assistants within the architecture 300 described above with reference to FIG. 3, including the global assistants 306, the custom assistants 308, and the contextual assistants 310. The analytics interface 500 may operate in a manner similar to the analytics interface 400 described above with reference to FIG. 4. For example, the analytics interface 500 may be used to present data and visualizations to users. The analytics interface 500 may also allow users to interact with data and initiate queries. In some cases, the analytics interface 500 may be embedded in external portals or applications. This embedding capability may allow users to access the functionality of the system 150 shown in FIG. 1B from within other software environments or platforms. The embedded analytics interface 500 may maintain its full range of capabilities, including access to the various tiers of assistants described in the architecture 300.

The analytics interface 500 includes a visualization 502. The visualization 502 may display data charts within the interface. In some cases, the visualization 502 may display other types of charts. For example, the visualization 502 may display bar charts, line charts, pie charts, or other chart types. The visualization 502 may present relevant metrics and information to a user. The visualizations may be generated using data processed by components of the architecture 300 shown in FIG. 3, such as the global assistants 306 or the contextual assistants 310. The visualizations may be dynamically updated based on user interactions and queries. For example, when a user selects a specific data point in one visualization, other visualizations in the analytics interface 500 may update to show related information. This dynamic updating may be facilitated by the associative engine 170 shown in FIG. 1B, which gathers contextual metadata about the user's current analytical context. This contextual metadata can include data hypercubes or subsets relevant to the query, a current selection state including filters applied such as specific regions, products, or time periods selected, a data model schema and relationships showing how fields and tables are connected, the user's selection or query history to maintain context in a conversational thread, and any annotations or rules defined in a corresponding analytics-system app.

With continued reference to FIG. 5, the analytics interface 500 includes a user question 504. Users may submit the user question 504 through the interface. The user question 504 may comprise a natural language query. For example, the user question 504 may read “How do I colour this chart to reflect measures?” as shown in FIG. 5. The user question 504 may function similarly to the natural language question 162 described above with reference to FIG. 1B. The user question 504 may allow users to request specific information or clarification regarding the visualization 502 or other aspects of the analytics interface 500. When a user inputs the user question 504, the query may be processed by the supervisor 302 shown in FIG. 3. The supervisor 302 may perform intent recognition on the user question 504 to determine the underlying intent or purpose. The supervisor 302 may analyze the content and context of the user question 504 to classify the query into functional categories. The functional categories may include analytical, administrative, help-seeking, or action-requesting categories. The supervisor 302 may then pass this intent information to the router 304 shown in FIG. 3. The router 304 may use this intent information to direct the user question 504 to the appropriate assistant within the global assistants 306.

The analytics interface 500 further includes an answer 506. The answer 506 may be generated in response to the user question 504. As shown in FIG. 3, the architecture 300 includes the help assistant 306C within the global assistants 306. The help assistant 306C may be configured to provide assistance with product documentation and usage. The user question 504 may be routed through the help assistant 306C of the architecture 300 based on the intent recognition performed by the supervisor 302 and the routing performed by the router 304. The help assistant 306C may process the user question 504 to generate the answer 506. The answer 506 may correspond to the answer 168 described above with reference to FIG. 1B. The answer 506 may be formulated using context 166 retrieved from the vector database 156 and processed by the large language model 160 as shown in FIG. 1B. The system 150 may utilize retrieval augmented generation to enhance responses. In some cases, the assistant application 158 may provide the retrieved context 166 to the large language model 160. The large language model 160 may use the context 166 to generate the answer 168, which is displayed as the answer 506.

As shown in FIG. 1B, the system 150 includes the vector database 156. The vector database 156 may store embeddings of documentation and other content. The embeddings may be generated through the data conversion process 154 shown in FIG. 1B, which includes the copy to cloud step 154A, the split into chunks step 154B, the create embeddings step 154C, and the store into vector step 154D. The vector database 156 may semantically index the embeddings, which involves organizing the numerical representations of the data chunks in a manner that reflects the semantic meaning of the content within each chunk. This semantic indexing may facilitate more efficient and accurate retrieval of information in response to queries.

The help assistant 306C may access documentation stored in the vector database 156 to retrieve relevant information by performing a search 164 against the vector database 156 to receive context 166. The help assistant 306C may access a knowledge base of product information to answer user queries about features, functionality, or troubleshooting. The help assistant 306C may formulate the answer 506 based on the retrieved information. For example, the answer 506 may comprise textual content providing instructions for coloring a chart by measures in an analytics application. The answer 506 may include steps such as opening chart properties, navigating to an appearance or colors section, selecting a color by measure option or color by expression option, choosing a specific measure to use for coloring, and selecting a color palette such as gradient, heat map, or custom colors.

In some cases, the answer 506 may include a request for additional information. For example, the answer 506 may indicate that more precise guidance would require additional context about the chart type, the specific measure to use for coloring, or the chart's current configuration. The answer 506 may be displayed in the analytics interface 500 in a clear, step-by-step format. The answer 506 may directly address the user question 504 submitted by the user. In some cases, the system may provide “explainable AI” by including references to the specific documentation sources used to generate the answer 506. The answer 506 may include links or citations to relevant help articles or user guides, allowing the user to explore the topic further if needed.

The interaction between the users 153 shown in FIG. 1B, the assistant application 158, and the large language model 160 may be iterative. In some cases, the system 150 may engage in a multi-turn conversation with the users 153, refining and expanding upon the initial user question 504 and answer 506. This iterative process may allow for more comprehensive and accurate responses to complex queries. The analytics interface 500 may also include tools for customizing the displayed visualizations. These tools may allow users to adjust parameters, apply filters, or change chart types. This functionality may be supported by the custom assistants 308 within the architecture 300 shown in FIG. 3, which may be designed to handle specific types of data manipulation or visualization tasks. The custom assistants 308 may be configured with knowledge 308B representing knowledge bases containing unstructured data sources, apps 308C representing linked analytics applications containing structured data through pre-built data models, and actions 308D representing automation workflows that may be triggered based on query results.

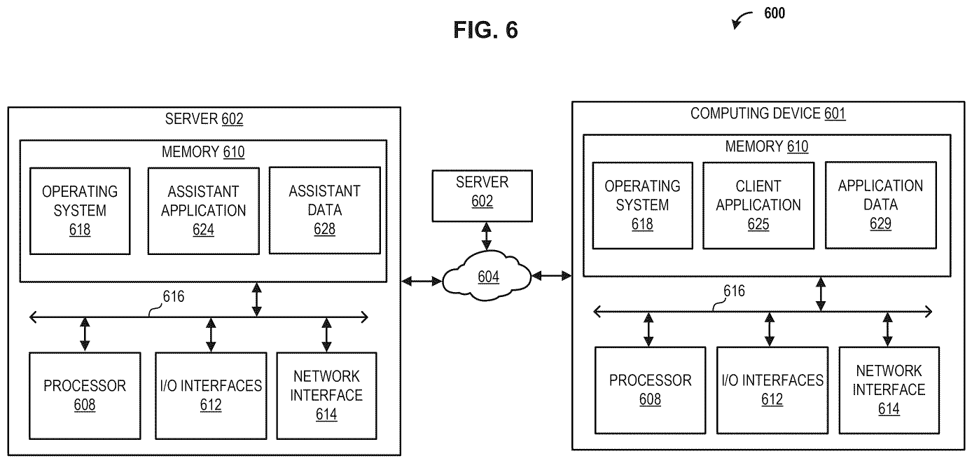

The present methods and systems may be computer-implemented. FIG. 6 shows a block diagram depicting a system/environment 600 comprising non-limiting examples of a computing device 601 and a server 602 connected through a network 604. Either of the computing device 601 or the server 602 may be a computing device, such as any of the devices of the system 100 shown in FIG. 1A. In an aspect, some or all steps of any described method may be performed on a computing device as described herein. The computing device 601 may comprise one or multiple computers configured to store application data 629, and/or the like. The server 602 may comprise one or multiple computers configured to store assistant data 628. Multiple servers 602 may communicate with the computing device 601 via the through the network 604.

The computing device 601 and the server 602 may be a digital computer that, in terms of hardware architecture, generally includes a processor 608, system memory 610, input/output (I/O) interfaces 612, and network interfaces 614. These components (608, 610, 612, and 614) are communicatively coupled via a local interface 616. The local interface 616 may be, for example, but not limited to, one or more buses or other wired or wireless connections, as is known in the art. The local interface 616 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 608 may be a hardware device for executing software, particularly that stored in system memory 610. The processor 608 may be any custom made or commercially available processor, a central processing unit (CPU), an auxiliary processor among several processors associated with the computing device 601 and the server 602, a semiconductor-based microprocessor (in the form of a microchip or chip set), or generally any device for executing software instructions. When the computing device 601 and/or the server 602 is in operation, the processor 608 may execute software stored within the system memory 610, to communicate data to and from the system memory 610, and to generally control operations of the computing device 601 and the server 602 pursuant to the software.

The I/O interfaces 612 may be used to receive user input from, and/or for providing system output to, one or more devices or components. User input may be provided via, for example, a keyboard and/or a mouse. System output may be provided via a display device and a printer (not shown). I/O interfaces 612 may include, for example, a serial port, a parallel port, a Small Computer System Interface (SCSI), an infrared (IR) interface, a radio frequency (RF) interface, and/or a universal serial bus (USB) interface.

The network interface 614 may be used to transmit and receive from the computing device 601 and/or the server 602 on the network 604. The network interface 614 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 614 may include address, control, and/or data connections to enable appropriate communications on the network 604.

The system memory 610 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 610 may incorporate electronic, magnetic, optical, and/or other types of storage media. Note that the system memory 610 may have a distributed architecture, where various components are situated remote from one another, but may be accessed by the processor 608.

The software in system memory 610 may include one or more software programs, each of which comprises an ordered listing of executable instructions for implementing logical functions. In the example of FIG. 6, the software in the system memory 610 of the computing device 601 may comprise the application data 629, the client application 625, and a suitable operating system (O/S) 618. In the example of FIG. 6, the software in the system memory 610 of the server 602 may comprise the assistant data 628, the assistant application 624, and a suitable operating system (O/S) 618. The operating system 618 essentially controls the execution of other computer programs and provides scheduling, input-output control, file and data management, memory management, and communication control and related services.

For purposes of illustration, application programs and other executable program components such as the operating system 618 are shown herein as discrete blocks, although it is recognized that such programs and components may reside at various times in different storage components of the computing device 601 and/or the server 602. An implementation of the system/environment 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

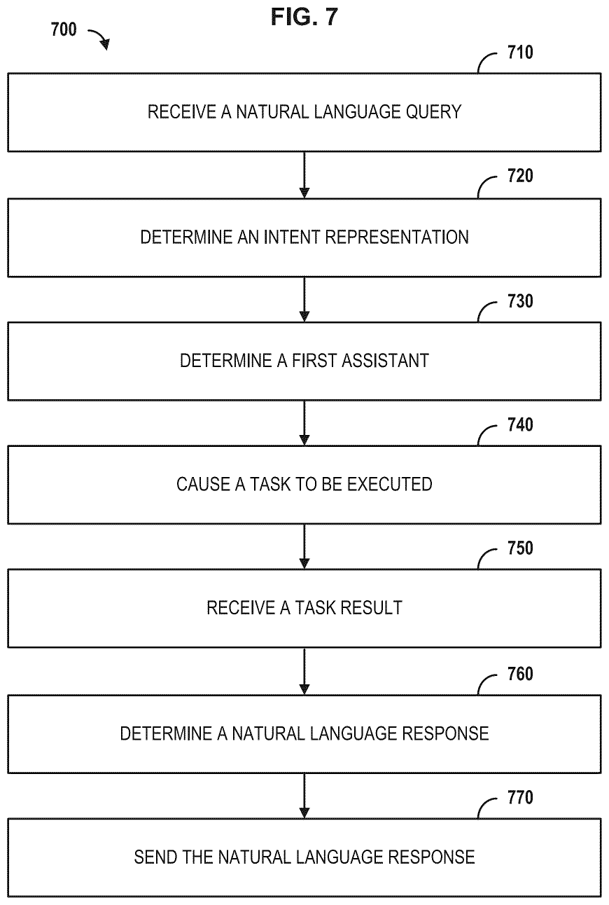

Referring to FIG. 7, a method 700 for processing natural language queries corresponding to the architecture 300 is illustrated. The method 700 may be performed by one or more computing devices. The method 700 may be performed in conjunction with the system 100 of FIG. 1A, the system 150 of FIG. 1B, and the architecture 300 of FIG. 3.

At step 710, a natural language query may be received from a user device associated with an assistant platform. The natural language query may be received by the assistant application 158 shown in FIG. 1B. The natural language query may correspond to the natural language question 162 shown in FIG. 1B. The user device may correspond to the computing device 102 shown in FIG. 1A, which may comprise the ML module 102A and the associative engine 102B. The natural language query may be received via a network. The network may be the network 104 . The natural language query may comprise a question, a command, or a combination thereof. The natural language query may relate to structured data, unstructured data, or a combination of structured and unstructured data. In some cases, the natural language query may comprise an image, a recording, a combination thereof, or the like. The one or more users 153 may interact with the assistant application 158 via a client device, such as the computing device 102, a mobile device, or a web browser.

At step 720, an intent representation comprising a query intent and a domain context may be determined based on the natural language query. The supervisor 302 may perform the determination of the intent representation. The supervisor 302 may serve as an initial point of contact for user queries. The supervisor 302 may receive queries from various user interfaces or input methods. The supervisor 302 may analyze the content and context of the natural language query to determine the underlying intent or purpose. The supervisor 302 may extract query intent beyond the literal text of the query. The supervisor 302 may identify implicit requirements, constraints, and desired outcomes.

The supervisor 302 may classify the natural language query into functional categories. The functional categories may include analytical, administrative, help-seeking, or action-requesting categories. The supervisor 302 may classify the natural language query along multiple dimensions. The multiple dimensions may include a functional intent, a domain context, data requirements, an execution profile for single or multi-agent execution, and a complexity level. In some cases, determining the intent representation may comprise classifying, via at least one large language model, the natural language query into the query intent and the domain context. The at least one large language model may be associated with the assistant platform. The at least one large language model may correspond to the large language model 160 shown in FIG. 1B, which may interact with the assistant application 158 to process natural language queries from users 153.

At step 730, a first assistant of a plurality of assistants may be determined based on the intent representation. Each assistant of the plurality of assistants may be associated with at least one data source. The at least one data source may correspond to the plurality of data stores 106, 108, 110 shown in FIG. 1A. The router 304 may perform the determination of the first assistant. The supervisor 302 and the router 304 may work in conjunction to process and route user queries efficiently. For example, when a user submits a query, the supervisor 302 may first analyze the query to determine its intent. The supervisor 302 may then pass this intent information to the router 304. The router 304 may use this intent information to direct the query to the appropriate component of the architecture 300 for further processing.

The router 304 may maintain a registry of all available assistants. Each assistant may be described by functional capabilities and specializations. Each assistant may be described by use cases and recommended query types. Each assistant may be described by domain applicability. Each assistant may be described by required data sources and integrations. Each assistant may be described by semantic descriptions for matching. The router 304 may perform semantic matching of query intent to assistant capabilities. The router 304 may use a semantic assistant selection algorithm. The semantic assistant selection algorithm may include candidate generation. The semantic assistant selection algorithm may include filtering by data requirements and permissions. The semantic assistant selection algorithm may include ranking by semantic similarity score and historical success rate. The semantic assistant selection algorithm may include selection of primary and secondary assistants. In some cases, determining the first assistant may comprise determining, based on the intent representation and at least one capability descriptor for each of the plurality of assistants, a similarity score for each of the plurality of assistants. Determining the first assistant may comprise determining, based on the similarity score, the first assistant.

The first assistant may be one of the global assistants 306 shown in FIG. 3. The global assistants 306 may comprise a set of platform-level assistants. The global assistants 306 may include the cross assistant 306A configured to handle queries requiring coordination between multiple specialized assistants, the platform assistant 306B configured to handle platform-specific actions, the help assistant 306C configured to provide assistance with product documentation and usage, and the global assistant N 306D representing additional extensible assistants. The first assistant may alternatively be one of the custom assistants 308. The custom assistants 308 may be user-created assistants designed for specialized tasks. The custom assistants 308 may include the assistant 1 308A and the assistant N 308N. The custom assistants 308 may be configured with knowledge 308B representing knowledge bases containing unstructured data sources, apps 308C representing linked analytics applications containing structured data through pre-built data models, and actions 308D representing automation workflows that may be triggered based on query results. The first assistant may alternatively be one of the contextual assistants 310. The contextual assistants 310 may be domain-specific assistants tailored to particular contexts. The contextual assistants 310 may include the data prep 310A assistant, the AutoML 310B assistant, the glossary 310C assistant, the data product 310D assistant, the role-based 310E assistant, and the assistant N 310N.

In some cases, the plurality of assistants may comprise at least one custom assistant associated with a data model. Determining the first assistant may comprise enforcing, based on a user role associated with the user device, an access rule that restricts selection of the at least one custom assistant. Understanding the access permissions and data visibility rules configured in an application may be part of the system's process, so details on user roles and their associated permissions may be included. The security rules may define access permissions and data visibility, ensuring that users only see the data they are authorized to access.

At step 740, execution of a task may be caused by a computation service of the assistant platform based on the first assistant and the at least one data source. The execution of the task may comprise evaluating a data model associated with the at least one data source. The data model may be evaluated based on the query intent and the domain context. The computation service may correspond to the associative engine 170 shown in FIG. 1B or the associative engine 102B shown in FIG. 1A. The associative engine 170 may store one or more data models in-memory and manage associations between data elements. Based on data elements within a data model, the associative engine 170 may provide near-instantaneous calculation of aggregates, selections, and filters.

In some cases, causing the execution of the task may comprise sending, via the first assistant, a query message encoding a maintained selection state to the associative engine 170. The associative engine 170 may implement the computation service and evaluate the data model. The maintained selection state may be stored, based on a session identifier associated with the natural language query, in a state store of the computation service and reused for multiple task executions within a session defined by the session identifier. When a user 153 sends a natural language question 162, the associative engine 170 gathers contextual metadata about the user's current analytical context. This contextual metadata can include, but is not limited to: data hypercubes or subsets relevant to the natural language question 162, a current selection state including filters applied such as specific regions, products, or time periods selected, a data model schema and relationships showing how fields and tables are connected, the user's selection or query history to maintain context in a conversational thread, and any annotations or rules defined in a corresponding analytics-system app.

In some cases, causing the execution of the task may further comprise triggering, based on a task result, an automation workflow that modifies a record in an external application. The automation workflow may be one of the actions 308D associated with the custom assistants 308. The global assistants 306 may include an automation agent. The automation agent may execute workflows and query processes. The automation agent may integrate with automation systems to trigger data operations. The automation agent may trigger query process workflows. The automation agent may trigger system integrations. The automation agent may trigger API calls to external systems.

At step 750, a task result may be received based on the execution of the task from the computation service. The task result may correspond to the context 166 shown in FIG. 1B. The task result may be received from the associative engine 170. The task result may include data responsive to the query intent and the domain context. The assistant application 158 may perform a search 164 against the vector database 156 in order to receive context 166. The context 166 may be based on the embeddings stored in the vector database 156, and the context 166 may be used by the assistant application 158 to provide an answer 168. The context 166 may comprise contextual metadata gathered by the associative engine 170.

At step 760, a natural language response may be generated based on the task result. The natural language response may correspond to the answer 168 shown in FIG. 1B. The large language model 160 from FIG. 1B may process the task result to generate the natural language response. The natural language response may be indicative of the query intent and the domain context. The system 150 may utilize retrieval augmented generation to enhance responses. In some cases, the assistant application 158 may provide the retrieved context 166 to the large language model 160. The large language model 160 may use the context 166 to generate the answer 168. The natural language response may comprise a natural language answer. The natural language response may comprise visualizations, charts, or tables. The natural language response may comprise insights derived from the task result. The assistant application 158 may be designed to provide responses in various formats. In some cases, the assistant application 158 may provide text-based responses. In other cases, the assistant application 158 may provide visual or auditory responses. For example, the assistant application 158 may generate a graphical representation of the response, or it may generate an audio file that verbally communicates the response, a combination thereof, or the like.

At step 770, the natural language response may be sent to the user device via the assistant platform. The natural language response may be sent via the network 104. The natural language response may be displayed in an analytics interface. The analytics interface may be the analytics interface 400 from FIG. 4 or the analytics interface 500 from FIG. 5. The assistant application 158 may be designed to interact with users 153 in a conversational manner. This may allow for more complex and dynamic interactions between the users 153 and the assistant application 158. For example, the assistant application 158 may be capable of maintaining a conversation with a user 153 over multiple exchanges, keeping track of the context of the conversation and providing responses that are relevant to the ongoing conversation. The interaction between the users 153, the assistant application 158, and the large language model 160 may be iterative. In some cases, the system 150 may engage in a multi-turn conversation with the users 153, refining and expanding upon the initial natural language query and natural language response. This iterative process may allow for more comprehensive and accurate responses to complex queries. Other examples are possible as well.

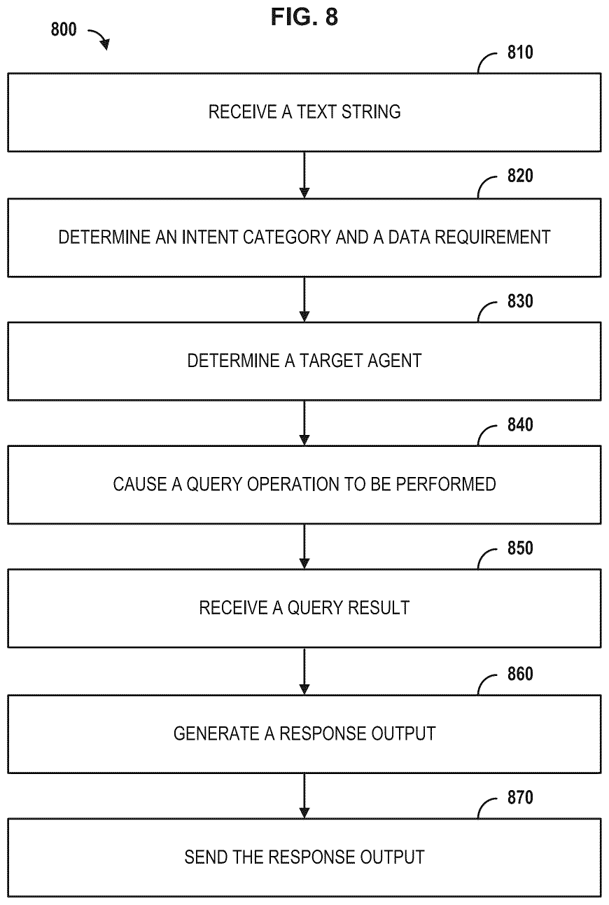

Referring to FIG. 8, a method 800 for processing requests using an agent registry corresponding to the architecture 300 is illustrated. The method 800 may be performed by one or more computing devices. The method 800 may be performed in conjunction with the system 100 of FIG. 1A, the system 150 of FIG. 1B, and the architecture 300 of FIG. 3.At step 810, a request comprising a text string may be received from a client device. The client device may be the client device 102. The text string may comprise a natural language query. The text string may be received via a network. The network may be the network 104. The request may be received by the supervisor 302 of the architecture 300. The text string may comprise a question, a command, or a combination thereof. The text string may relate to structured data, unstructured data, or a combination of structured and unstructured data.

At step 820, an intent category and a data requirement may be determined based on the request comprising the text string. The supervisor 302 may perform the determination of the intent category and the data requirement. The supervisor 302 may analyze the text string to extract query intent beyond literal text. The supervisor 302 may identify implicit requirements, constraints, and desired outcomes from the text string. The intent category may indicate a type of operation. The type of operation may be a data query, an administrative task, a help request, an action request, or a multi-intent operation comprising a combination of operation types. The data requirement may indicate whether structured data, unstructured data, or both structured and unstructured data are needed to process the request. The supervisor 302 may generate context about a user associated with the request. The context may include user permissions and a current workflow of the user. The supervisor 302 may classify the text string into functional categories. The functional categories may include analytical, administrative, help-seeking, and action-requesting categories.

With continued reference to FIG. 8, at step 830, a target agent may be determined from a plurality of agents based on the intent category, the data requirement, and a stored registry of agent entries. The router 304 may perform the determination of the target agent. Each agent entry in the stored registry of agent entries may identify at least one agent of the plurality of agents and at least one analytics application. The plurality of agents may include the global assistants 306, the custom assistants 308, and the contextual assistants 310. The stored registry of agent entries may comprise metadata describing each agent. The metadata may include functional capabilities, specializations, use cases, recommended query types, domain applicability, required data sources, integrations, and semantic descriptions for matching.

Determining the target agent may comprise determining, based on the intent category and metadata in the stored registry of agent entries, a ranking of the plurality of agents. The ranking may be based on semantic similarity between the intent category and the metadata. The ranking may also be based on historical success rates for similar queries. Determining the target agent may further comprise selecting, based on the ranking of the plurality of agents, the target agent. The metadata may be indicative of the target agent being capable of processing the request. The router 304 may perform semantic matching of the intent category to agent capabilities described in the metadata. The router 304 may filter agents based on the data requirement. The router 304 may filter agents based on user permissions associated with the request.

As further shown in FIG. 3, the target agent may be one of the global assistants 306. The global assistants 306 may include the cross assistant 306A, the platform assistant 306B, the help assistant 306C, and the global assistant N 306D. The target agent may alternatively be one of the custom assistants 308. The custom assistants 308 may include the assistant 1 308A and the assistant N 308N. The custom assistants 308 may be configured with knowledge 308B, apps 308C, and actions 308D. The knowledge 308B may represent knowledge bases containing unstructured data sources. The apps 308C may represent linked analytics applications containing structured data. The actions 308D may represent automation workflows. The target agent may alternatively be one of the contextual assistants 310. The contextual assistants 310 may include the data prep 310A assistant, the AutoML 310B assistant, the glossary 310C assistant, the data product 310D assistant, the role-based 310E assistant, and the assistant N 310N.

Referring again to FIG. 8, at step 840, a query operation may be caused to be performed against a data model based on the target agent and the at least one analytics application. The data model may be associated with the at least one analytics application. Causing the query operation to be performed may comprise causing, via the target agent, an associative engine to evaluate the data model based on the intent category and the data requirement. The associative engine may be the associative engine 170 from FIG. 1B. The associative engine 170 may store one or more data models in-memory and manage associations between data elements.

Causing the query operation may comprise sending, based on the data requirement, a query message comprising a filter condition to the associative engine 170. The associative engine 170 may evaluate the data model based on the filter condition. The associative engine 170 may maintain a selection state across queries. The selection state may represent a global context. The associative engine 170 may perform incremental calculations based on the selection state. For example, the associative engine 170 may provide sub-500 millisecond response times for incremental queries.

Referring again to FIG. 8, at step 850, a query result may be received based on the query operation. The query result may be received from the associative engine 170. The query result may include data responsive to the filter condition. The query result may include related patterns discovered through the power of gray capability. The query result may include lineage information and confidence metrics.

At step 860, a response output may be generated based on the query result. Generating the response output may comprise generating, via the associative engine 170 and based on the filter condition, output data. The response output may be based on the output data. The large language model 160 from FIG. 1B may process the query result to generate the response output. The response output may comprise a natural language answer. The response output may comprise visualizations, charts, or tables. The response output may comprise insights derived from the query result.

At step 870, the response output may be sent to the client device. The response output may be sent via the network 104. The response output may be displayed in an analytics interface. The analytics interface may be the analytics interface 400 or the analytics interface 500. The method 800 may further comprise determining, based on the intent category and the query result, a follow-up action. The follow-up action may be determined when the intent category indicates an action request or a multi-intent operation. The method 800 may further comprise causing, via the target agent, the follow-up action to be performed. For example, the follow-up action may comprise sending an email, creating a task in an external system, generating a report, or updating a record in a customer relationship management system. The follow-up action may comprise triggering an automation workflow. The automation workflow may be one of the actions 308D associated with the custom assistants 308. Other examples are possible as well.

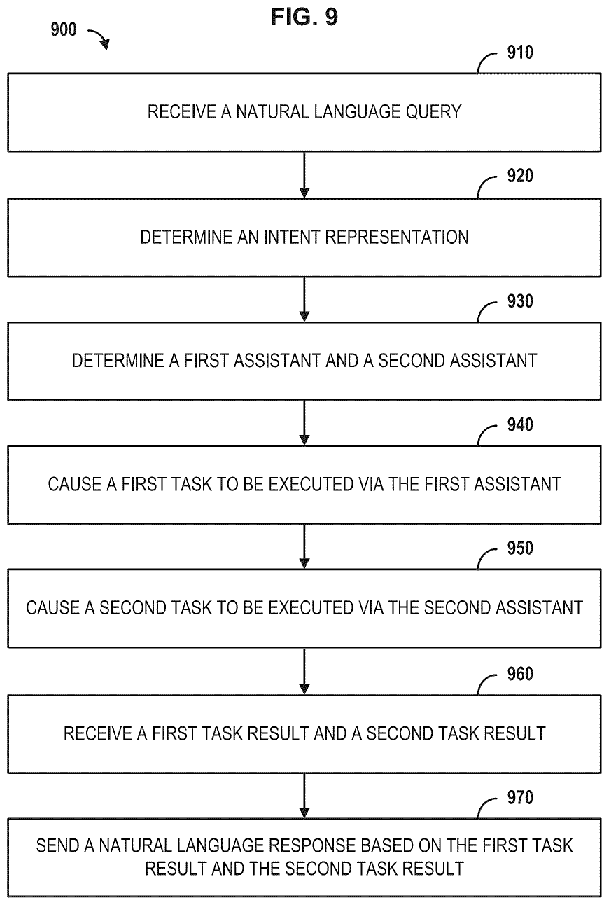

Referring to FIG. 9, a method 900 for processing natural language queries using multiple assistants is shown. The method 900 may be performed by components of the system 150 shown in FIG. 1B and the architecture 300 shown in FIG. 3. The method 900 may enable multi-agent orchestration where a single query requiring multiple assistants may be decomposed into constituent parts. The method 900 may support parallel multi-agent execution where multiple agents execute simultaneously with results synchronized and combined into a unified response. The method 900 may also support sequential multi-agent workflows where results from one agent become input to the next agent. The multi-agent architecture may provide advantages including parallel processing of independent tasks, context continuity where results flow from one agent to the next with full context, error recovery where if one agent fails the system can request an alternative approach, reasoning transparency where each step in the chain is logged and explainable, and specialization where each agent is optimized for its domain rather than attempting one monolithic agent.

At step 910, a natural language query may be received. The natural language query may be received via the assistant application 158 shown in FIG. 1B. The natural language query may be submitted by one or more users 153 through a client device 102. The natural language query may comprise a question or request expressed in natural language text. The assistant application 158 may receive the natural language query through an analytics interface such as the analytics interface 400 shown in FIG. 4 or the analytics interface 500 shown in FIG. 5. The natural language query may require multiple assistants working in sequence with results from one assistant informing the execution of another. For example, a query such as “Find customers we don't have solutions for yet, based on our competitive positioning, and create personalized emails asking them to meetings” may require a data query to find customers, a knowledge lookup for competitive positioning, and an action automation for emails.

At step 920, an intent representation may be determined based on the received natural language query. With reference to FIG. 3, the supervisor 302 may perform intent recognition on the natural language query. The supervisor 302 may analyze the natural language query to extract query intent beyond literal text. The supervisor 302 may identify implicit requirements, constraints, and desired outcomes. The supervisor 302 may classify the natural language query into functional categories. The functional categories may include analytical queries, administrative queries, help-seeking queries, action-requesting queries, or multi-intent queries comprising a combination of operation types. The intent representation may comprise information about the user, user permissions, and a current workflow context. The supervisor 302 may classify the natural language query along multiple dimensions including a functional intent, a domain context, data requirements, an execution profile for single or multi-agent execution, and a complexity level. When the supervisor 302 detects that a single query requires multiple assistants, the supervisor 302 may decompose the query into constituent parts matching different assistants' specializations. The supervisor 302 may determine an execution sequence as sequential or parallel based on dependencies between the constituent parts.

At step 930, a first assistant and a second assistant may be determined based on the intent representation. With continued reference to FIG. 3, the router 304 may determine the first assistant and the second assistant. The router 304 may maintain a registry of available assistants. Each assistant in the registry may be described by functional capabilities and specializations, use cases and recommended query types, domain applicability, required data sources and integrations, and semantic descriptions for matching. The first assistant and the second assistant may be selected from among the global assistants 306, the custom assistants 308, or the contextual assistants 310. The router 304 may perform semantic matching of the intent representation to assistant capabilities. The router 304 may use a semantic assistant selection algorithm. The semantic assistant selection algorithm may include candidate generation, filtering by data requirements and permissions, ranking by semantic similarity score and historical success rate, and selection of primary and secondary assistants. The router 304 may identify that the natural language query requires coordination between multiple specialized assistants. For example, the first assistant may be the cross assistant 306A from the global assistants 306. The second assistant may be selected from the contextual assistants 310 such as the data prep 310A, the AutoML 310B, the glossary 310C, the data product 310D, or the role-based 310E assistant. In some cases, the first assistant may be selected from the custom assistants 308 such as the assistant 1 308A. The custom assistants 308 may be configured with knowledge 308B representing knowledge bases containing unstructured data sources, apps 308C representing linked analytics applications containing structured data through pre-built data models, and actions 308D representing automation workflows that may be triggered based on query results. The router 304 may route to a primary assistant and pass primary results to a secondary assistant with context and reasoning. The router 304 may perform adaptive routing comprising routing adjustments made based on interim results during query execution.

At step 940, a first task may be caused to be executed via the first assistant. The first task may correspond to a portion of the natural language query. The first assistant may access the vector database 156 shown in FIG. 1B to retrieve context 166 relevant to the first task. The first assistant may interact with the large language model 160 to process the first task. The first assistant may also interact with the associative engine 170 to gather contextual metadata about a current analytical context. For sequential multi-agent workflows, the first assistant may be a primary assistant such as an analytics agent for data queries. The first assistant may query applications and underlying data models. The first assistant may leverage the associative engine 170 directly rather than relying on text-to-SQL translation. The first assistant may access pre-curated, governed data models with metrics, dimensions, and KPIs. The first task may produce a first task result that becomes context for the second assistant.

At step 950, a second task may be caused to be executed via the second assistant. The second task may correspond to another portion of the natural language query. The second task may be executed in parallel with the first task when the first task and the second task are independent. The parallel execution may enable independent tasks to execute simultaneously. The second assistant may access the vector database 156 to retrieve context 166 relevant to the second task. The second assistant may interact with the large language model 160 to process the second task.

In some cases, the second task may depend on results from the first task. In such cases, the second task may be executed sequentially after the first task completes. For sequential execution, results from the first assistant may become context for the second assistant. The second assistant may execute with enriched context comprising the first task result. For example, if the first assistant is an analytics agent that returns a customer list, the second assistant may be an unstructured data agent that receives the customer list as context and performs a semantic search for competitive positioning based on the customer profiles. The second assistant may pass results to a third assistant such as an automation agent. The automation agent may execute workflows and query processes. The automation agent may integrate with automation systems to trigger data operations, query process workflows, system integrations, and API calls to external systems. The automation agent may create emails for each customer emphasizing key competitive positioning points and schedule meetings.

At step 960, a first task result and a second task result may be received. The first task result may be received from the first assistant. The second task result may be received from the second assistant. The first task result and the second task result may be synchronized. The synchronization may combine outputs from both assistants into a unified result set. For parallel multi-agent execution, the first task result and the second task result may be received simultaneously and synchronized into a combined result. For sequential multi-agent execution, the first task result may be passed to the second assistant as context before the second task is executed. The second task result may incorporate information from the first task result. The method 900 may support receiving task results from more than two assistants. For example, a third task result may be received from a third assistant such as an automation agent. The task results may include lineage information and confidence metrics. The task results may include related patterns discovered through associative relationships in the data.

At step 970, a natural language response may be sent based on the first task result and the second task result. The natural language response may be generated by the large language model 160. The large language model 160 may synthesize the first task result and the second task result into a coherent response. The synthesis may combine outputs from all assistants involved in processing the natural language query. The natural language response may be sent to the users 153 via the assistant application 158. The natural language response may be displayed in a chatbox such as the chatbox 402 shown in FIG. 4.

The natural language response may provide a comprehensive answer combining insights from both the first assistant and the second assistant. For example, the natural language response may indicate that a specified number of high-priority customers without solutions were identified, that based on competitive positioning analysis personalized emails were created and sent, and that expected meeting confirmations are anticipated within a specified time period. The natural language response may include a summary of actions taken by each assistant in the multi-agent workflow. Each step in the chain of reasoning may be logged and explainable. The multi-agent approach with result passing may enable more sophisticated reasoning than single agents with broad capabilities. The associative engine's performance may allow many sequential queries without latency penalties. Results from one agent may become context rather than just data for the next agent. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising
receiving, via an assistant platform, a natural language query from a user device associated with the assistant platform;
determining, based on the natural language query, an intent representation comprising a query intent and a domain context;
determining, based on the intent representation, a first assistant of a plurality of assistants, wherein each assistant of the plurality of assistants is associated with at least one data source;
causing, based on the first assistant and the at least one data source, an execution of a task by a computation service of the assistant platform, wherein the execution of the task comprises evaluating a data model associated with the at least one data source, wherein the data model is evaluated based on the query intent and the domain context;
receiving, based on the execution of the task, a task result from the computation service;
generating, based on the task result, a natural language response; and
sending, to the user device via the assistant platform, the natural language response.

2. The method of claim 1, wherein determining the intent representation comprises classifying, via at least one large language model, the natural language query into the query intent and the domain context, wherein the at least one large language model is associated with the assistant platform.

3. The method of claim 1, wherein the plurality of assistants comprises at least one custom assistant associated with the data model, and wherein determining the first assistant comprises enforcing, based on a user role associated with the user device, an access rule that restricts selection of the at least one custom assistant.

4. The method of claim 1, wherein determining the first assistant comprises: determining, based on the intent representation and at least one capability descriptor for each of the plurality of assistants, a similarity score for each of the plurality of assistants; and determining, based on the similarity score, the first assistant.

5. The method of claim 1, wherein causing the execution of the task comprises sending, via the first assistant, a query message encoding a maintained selection state to an associative engine, wherein the associative engine implements the computation service and evaluates the data model.

6. The method of claim 5, wherein the maintained selection state is stored, based on a session identifier associated with the natural language query, in a state store of the computation service and reused for multiple task executions within a session defined by the session identifier.

7. The method of claim 1, wherein causing the execution of the task further comprises triggering, based on the task result, an automation workflow that modifies a record in an external application.

8. A method comprising
receiving, from a client device, a request comprising a text string;
determining, based on the request comprising text string, an intent category and a data requirement;
determining a target agent from a plurality of agents based on: the intent category, the data requirement, and a stored registry of agent entries, wherein each agent entry in the stored registry of agent entries identifies at least one agent, of the plurality of agents, and at least one analytics application;
causing, based on the target agent and the at least one analytics application, a query operation to be performed against a data model, wherein the data model is associated with the at least one analytics application;
receiving, based on the query operation, a query result;
generating, based on the query result, a response output; and
sending, to the client device, the response output.

9. The method of claim 8, wherein causing the query operation to be performed comprises causing, via the target agent, an associative engine to evaluate the data model based on the intent category and the data requirement.

10. The method of claim 8, wherein the plurality of agents comprises a first tier of agents that are shared across multiple tenants and a second tier of agents that are associated with respective tenants, and wherein the stored registry of agent entries comprises, for each agent in the second tier of agents, a tenant identifier.

11. The method of claim 8, determining the target agent comprises:
determining, based on the intent category and metadata in the stored registry of agent entries, a ranking of the plurality of agents; and
select, based on the ranking of the plurality of agents, the target agent, wherein the metadata is indicative of the target agent being capable of processing the request.

12. The method of claim 8, wherein causing the query operation comprises sending, based on the data requirement, a query message comprising a filter condition to an associative engine, wherein the associative engine evaluates the data model based on the filter condition.

13. The method of claim 12, wherein generating the response output comprises generating, via the associative engine and based on the filter condition, output data, wherein the response output is based on the output data.

14. The method of claim 8, further comprising:
determining, based on the intent category and the query result, a follow-up action; and
causing, via the target agent, the follow-up action to be performed.

15. A system comprising:
an assistant platform comprising a plurality of assistants;
a first assistant, of the plurality of assistants, configured to:
receive, via the assistant platform, a natural language query associated with the assistant platform;
determine, based on the natural language query, an intent representation comprising a query intent and a domain context;
cause, based on the query intent and the domain context, execution of a task by an associative engine;
receive, based on the execution of the task, a task result from the associative engine; and
generate, based on the task result, a natural language response, wherein the natural language response is indicative of the query intent and a domain context; and
the associative engine configured to:
receive, via the first computing device, the task;
cause the task to be executed, wherein execution of the task comprises evaluating a data model, wherein the data model is associated with the domain context; and
send, to the first assistant, the task result.

16. The system of claim 15, wherein the first assistant is further configured to determine the intent representation by classifying, via at least one large language model, the natural language query into the query intent and the domain context.

17. The system of claim 16, wherein the at least one large language model is associated with the assistant platform.

18. The system of claim 15, wherein the data model is an in-memory data model.

19. The system of claim 15, the associative engine stores the data model in memory prior to executing the task.

20. The system of claim 15, wherein the data model is associated with a plurality of data dimensions, and wherein the natural language query is indicative of at least one data dimension of the plurality of data dimensions.
